(19) United States
(12) Patent Application Publication
(10) Pub. No.: US 2003/0150291 A1
(43) Pub. Date: Aug. 14, 2003

(54) Hand crank for a lifting jack

(76) Inventor: Nelson Grenier, Ste-Marie Beauce (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/356,573

(22) Filed: Feb. 3, 2003

Related U.S. Application Data
(63) Continuation-in-part of application No. 09/694,270, filed on Oct. 24, 2000, now abandoned.

(51) Int. Cl. G05G 1/00

(52) U.S. Cl. 74/545

(57) ABSTRACT

A hand crank for actuating a gear assembly mechanism such as for a lifting jack is described. The hand crank comprises an elongated metal primary handle, a tube bent at very precise angles to define two spaced-apart handle portions, separated from one another in parallel planes, by a central portion. A connector includes a bracket that has a V-shaped slot to secure the hand crank to a gear actuator at two alternate working positions and a storage position. When in the first position, the handles of the hand crank are parallel to a longitudinal axis of the actuator and define a high-speed position. When in the second position, the two handle portions are parallel to the longitudinal axis of the actuator. The handle portions are spaced about 8.5 inches from one another and about the same distance apart to constitute an ergonomic disposition when used at their first position. In the second position, the central portion lies at an angle when used at their first position slightly less than 90° from the horizontal axis to maintain the connector rigidly secured and the outer handle portion acts as the cranking lever.

This is a Continuation-In-Part of patent application Ser. No. 09/694,270 filed Oct. 24, 2000.

### FIELD OF THE INVENTION

The present invention relates to an ergonomic hand crank for actuating a gear coupling mechanism such as those coupled to vehicle landing gears.

### BACKGROUND OF THE INVENTION

The closest prior art is exemplified by U.S. Pat. No. 5,904,342 which relates to a landing gear crank handle which will be described in more detail later with reference to FIG. 1. The two major drawbacks of the prior art crank handle are the parallel spacing of the handles and the angle of the central portion of handle which make the entire crank strainful to use.

### SUMMARY OF THE INVENTION

It is a feature of the present invention to provide a hand crank for rotating an actuator which extends on a horizontal actuating axis and which overcomes the drawbacks of the closest prior art referred to herein above.

Another feature of the present invention is to provide a hand crank for rotating an actuator lying on a horizontal actuating axis and wherein the handle portions of the actuator as well as its central interconnecting portion provides for a hand crank which is more comfortable to use, which can rotate the actuator at a higher speed and which is totally ergonomic due to its precise configuration and dimensions.

According to the above features, from a broad aspect the present invention provides a hand crank for rotating an actuator lying on a horizontal actuating axis. The hand crank comprises a connector including a bracket for alternatively securing the hand crank to the actuator in one of first and second working positions. A tubular crank member is provided with two tubular handle portions extending from opposed ends of an angulated central tubular straight portion, respectively. The handles have central horizontal axes which are parallel to one another. One of the two handle portions merges into an angulated connecting portion secured to the connector. The connector, when in the first working position, places the tubular crank member in a horizontal extension with the two handle portions parallel with the horizontal actuating axis. The handle portions are spaced-apart a vertical and horizontal critical distance of about 8½ inches to achieve a comfortable hand cranking position and a maximum torquing radius. The connector, when in the second working position, the tubular crank member extends angularly downwards at an angle of about 33° with respect to the horizontal actuating axis. The central tubular straight portion lies at an inward angle slightly less than 90° from the horizontal actuating axis to maintain the connector rigidly secured to the actuator without the need of an operator applying an inward force to the hand crank.

### BRIEF DESCRIPTION OF THE DRAWINGS

The preferred embodiments of the present invention will now be described with reference to the accompanying drawings in which

FIG. 1, which is labeled Prior Art, is a side elevational view of a conventional hand crank mounted on a vehicle landing gear;

FIG. 2 is a side elevational view of the hand crank of the present invention illustrating the precise configuration thereof;

FIG. 3A is a side elevational view of the hand crank of FIG. 2, mounted on the lifting jack according to a first high-speed position; and

FIG. 3B is a side elevational view of the hand crank of the present invention; the hand crank is illustrated mounted on a vehicle landing gear according to a second alternate intermediate lower speed position.

### DESCRIPTION OF PREFERRED EMBODIMENTS

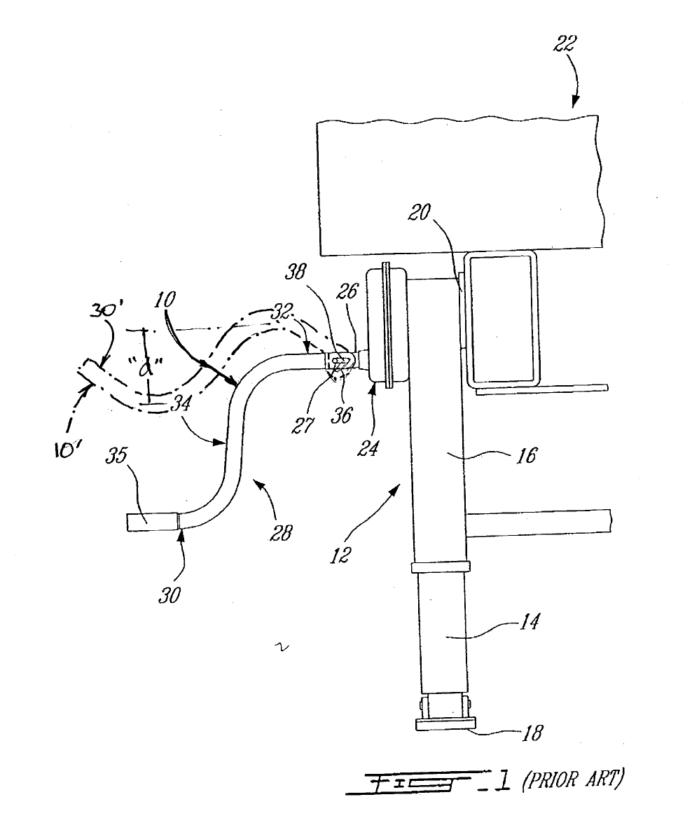

Referring now to the drawings, FIG. 1 (which is labeled “Prior Art”) shows a conventional hand crank 10 for actuating a vehicle lifting jack 12. The crank handle is shown in solid line at its intermediate position and at its high-speed position illustrated in stippled lines.

The vehicle lifting jack 12 comprises a pair of telescopic tubes 14, 16, a base 18 mounted to the inner tube 14, a mounting bracket 20, securing the outer tube 16 to the vehicle 22 (partially shown) and a rotatable gear coupling mechanism 24 having a rotatable actuator 26. The actuator 26 further includes a transversal pin 27 integrally mounted thereto and extending radially therefrom.

In operation, the rotation of the actuator 26 is transformed, through the gear coupling mechanism 24, into a longitudinal movement of the inner tube 14 in the outer tube 16, causing the vehicle 18 to be lifted or lowered with respect to the ground according to the direction of rotation of the actuator 26. Such lifting jacks are believed to be well known to persons skilled in the art and will not be described in more detail therein.

The conventional hand crank 10 is a rod or tube 28 bent to define a handle portion 30, a connecting portion 32 generally parallel to the handle portion 30 and a lever portion 34 perpendicularly positioned between the handle portion 30 and the connecting portion 32.

A rotatable cylinder 35 is optionally coaxially mounted to the handle portion 30 to help prevent friction between the operator's hand and the handle portion 30 while operating the hand crank 10.

The connecting portion 32 of the bent rod 28 is secured to the actuator 26 via a bracket 36 that includes a longitudinal aperture 38.

The bracket 36 is so mounted onto the actuator 26 as to position the transversal pin 27 into the transversal aperture 38 of the bracket 26. As will appear obvious to a person skilled in the art, the transversal pin 27 prevents the rotation of the bracket 36 about the actuator 26 when the hand crank 10 is operated. Thus, in operation, the rotation of the hand crank 10 causes the rotation of the actuator 26. However, care must be taken to assure that the bracket 36 does not disconnect from the pin so inward pressure must be maintained during cranking. The longitudinal aperture 38 of the bracket 36 allows longitudinal movement of the bracket 36 along the actuator 26 to disengage the bracket 36 from the actuator 26 and hang from the transversal pin 27 and be secured in a storage position. The bracket 36 is so configured and sized as to allow such movement.

When the crank handle of the prior art is at its horizontal high-speed position 10; the distance “d” between the handle portions 30 and 30″ is about 8 inches and the handles are spaced from one another slightly more than 11 inches. This disposition of the handles has been found to be strainful on the arms and shoulders of the user and constant movement between the pin 27 and connector takes place and sometimes causing the pin to move out of the slot making the crank wobbly.

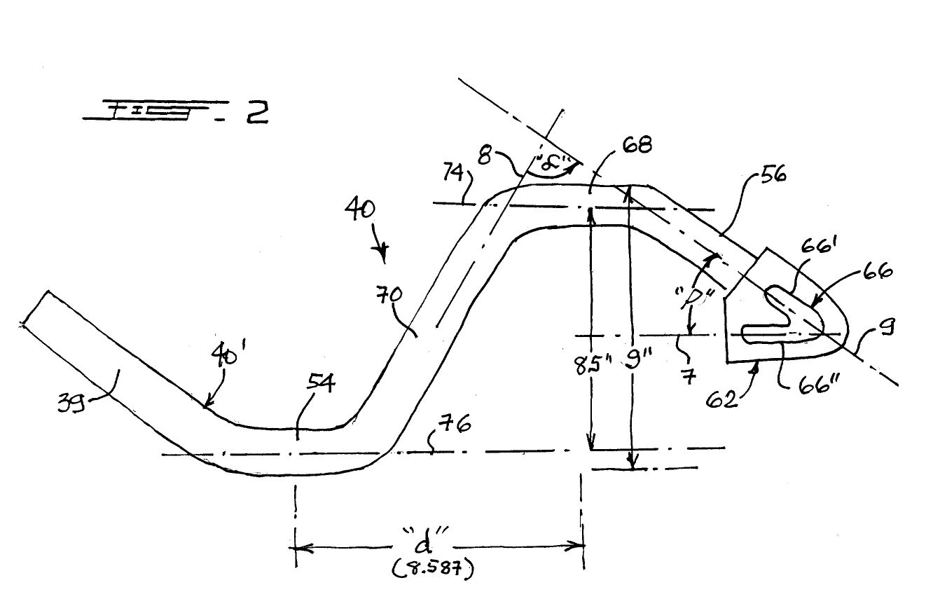

Referring to FIG. 2 there is shown the improved hand crank 40 of the present invention. This crank is formed from a tubular member 40′ having an outer radius of 1.29 inches and a total length of 27.817 inches. This tubular member is bent in the configuration as hereinshown having characteristics which are extremely important for the proper functioning of the hand crank and for comfort of use to a user person.

As shown, the hand crank 40 has a free end portion 39 which merges into a primary or first handle portion 54 which interconnects with a second handle portion 68 through a central straight angulated portion 70. The second handle portion 68 connects to an end connector or bracket 62 through an angled crank portion 56. The bracket 62 connects to the connector pin of the actuator rod of a gear box, as will be described later.

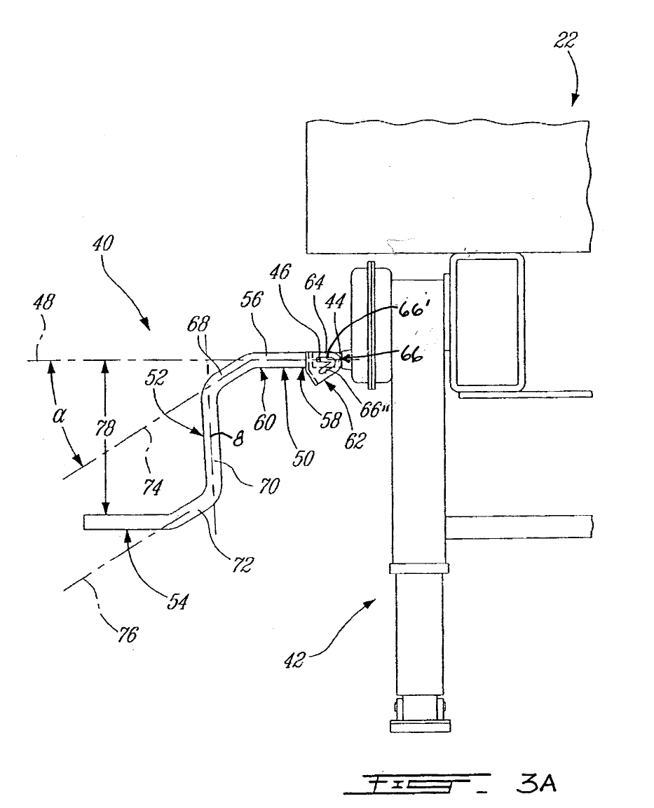

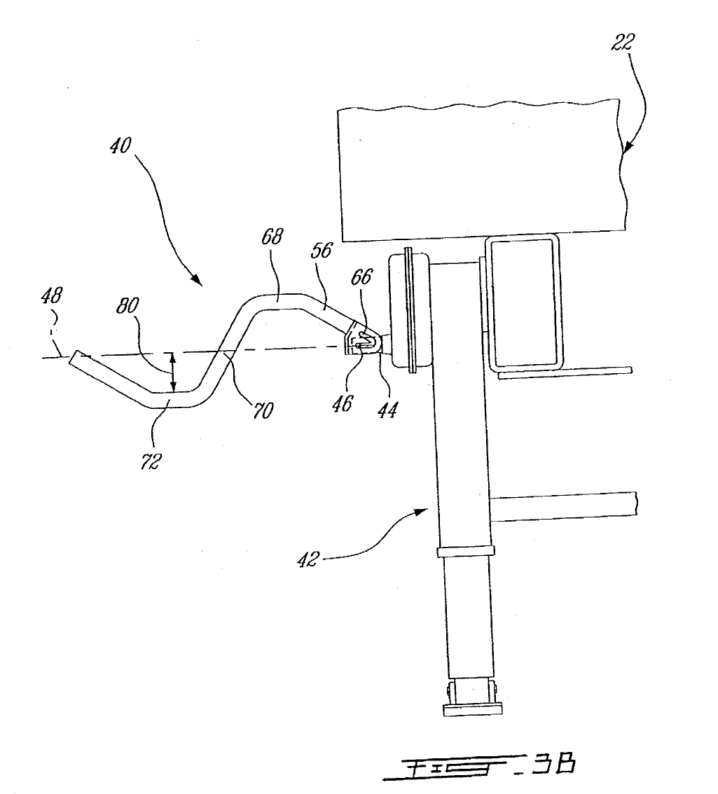

As hereinshown the connector 62 is provided with a V-shaped slot 62 having a first leg 66′ aligned with tubular portions 56 and the long axis 9 of which is disposed at slightly less than 90° with respect to the longitudinal axis 8 of the central tubular straight portion 70. This angle maintains a good connection between the first leg 66′ and the connector pin when the crank is secured for operation in its secondary angular position of 33°, as will be described later with reference to FIG. 3A.

An important feature of the crank as hereinshown is that the distance “d” between the primary and secondary handle portions 54 and 68 is brought in to approximately 8½ inches as compared to 11 inches with the prior art crank. More precisely, this distance for the crank handle as hereinshown is 8.587 inches. Another important feature is that the handle portions, which extend parallel to one another are spaced-apart a distance of 9 inches when measured transversely from their outer surfaces or 8½ inches when measured center to center, as illustrated in FIG. 2. This permits the transmission of more torque to the actuator as compared to the prior art crank.

As hereinshown the jaw connector 66 is also provided with a second leg portion 66′ and it extends at an angle ∝ which is approximately 33°. The angle ∝ is the angle between the two central longitudinal axes of the legs 66′ and 66″. As can be seen the longitudinal axis 7 extending through the leg 66″ is parallel with the longitudinal axis of the handle portions 54 and 68 when the crank is secured for high-speed connection with the actuator, as will be described later with reference to FIGS. 3A and 3B. In that position, because the handles are closer to one another and spaced-apart a distance of 8½ inches center to center this makes it very comfortable for the operator to crank the actuator at high-speed. These specific dimensions of the crank handle are not obvious and it is with experimentation and research that it was found to be the ideal ergonomic design for comfortable use for high-speed rotation and high torque transmission. It alleviates the muscular pain which is provoked by the designs of the prior art wherein more effort is required to generate the torque and wherein the spacing of the hands are too far apart resulting in muscular strain.

Turning now to FIG. 3A of the appended drawings the hand crank 40 according to a preferred embodiment of the present invention will be described in its second working positions. As illustrated, the hand crank 40 can be mounted on a vehicle lifting jack 42. The lifting jack 42 includes a rotatable actuator 44 provided with a transverse connecting pin 46 extending radially therefrom. The actuator 44 is centered about an actuating axis 48. Since the lifting jack 42 is similar to the lifting jack 12 of FIG. 1, and well known in the art, it will not be described in more detail herein.

The hand crank 40 is connected to the actuator by the bracket 62 having two side plates 64 (only one shown), a top wall and a bottom wall (both not shown). The two side plates 64 and the top and bottom walls together define a partial enclosure secured to the proximate end of the crank portion 56 by welding or other securing means.

The side plates 64 include a V-shaped slot 62 to receive the transversal pin 46 of the actuator 44. More precisely, the two legs of the slot 66 define an angle “P” of approximately 33°. The V-shaped slot 66 is so positioned as to have one of its legs 66′ aligned with the first member 56. The bracket 62 is configured and sized and is so secured to the crank portion 56 to allow for displacement of the pin of the actuator 46 in the V-shaped slot 66.

As above described, the crank is preferably made of an integral rod or tube that has been bent to form the corresponding above-described portions of the crank 40. Alternatively, these portions can be secured by welding or other fastening means.

The operation of the hand crank will now be described in more detail.

In FIG. 3A the hand crank 40 is illustrated in its second working position. According to this second position, the connector pin 46 of the rotatable actuator 44 is inserted in the leg 66′ of the V-shaped slot 66 that is parallel to the actuating axis 48. When the hand crank is in this second working position, it is operated by rotating the end portion 39 about the actuating axis 48, with the secondary member acting as a lever.

It is to be noted that, in this second position, the rotation of the end portion 39 about the actuating axis 48 defines a circle having a relatively long radius 78. It is well known to a person skilled in the art, that this relatively long radius 78 makes the crank 40 easier to rotate. Therefore, the hand crank 40 can be used in the second position when relatively more strength is required to rotate the actuator 44. An important design feature of the crank is that the central portion 70 extends at an angle of less than 90° and preferably 90° with respect to the rotational actuating axis 48 of the actuator. This permits the connector pin 46 to remain at the abutment end of the slot leg 66′.

Turning now to FIG. 3B, the operation of the hand crank 40 is illustrated with the crank 40 being in its first working high-speed position. According to this position, the connector pin 46 of the actuator 44 is inserted in the slot leg 66′ of the V-shaped slot 66 that defines an angle with the crank portion 56, placing the first and second handle portions 68 and 72 generally parallel to the actuating axis 48. When it is mounted to the actuator 44 according to the first position, the hand crank 40 is operated by rotating the hand crank 40 using two hands respectively on the first and second handles portion 68 and 72. According to this second alternate position, the central portion 70 of the secondary member 52 acts as the lever.

It is to be noted that, in this first “high-speed” position, the rotation of the handle portions 68 and 72 about the actuating axis 48 defines a circle having a second radius 80 smaller than the relatively long radius 78, illustrated in FIG. 3A, but at its maximum ergonomic radius as previously described. As it is believed well known to a person skilled in the art, this relatively shorter radius 80 gives less strength to the hand crank 40 than when it is positioned according to the second position, but more speed since the second radius 80 is smaller than the first radius 78. Therefore, the hand crank 40 is used in the second position when relatively less strength is required to rotate the actuator 44. The hand crank 40 can be used in the first position, for example, to begin lowering the lifting jack 42.

It is pointed out that it is within the ambit of the present invention to cover any obvious modifications of the preferred embodiment described herein provided such modifications fall within the scope of the appended claims

1. A hand crank for rotating an actuator lying on a horizontal actuating axis, said hand crank comprising:
a connector including a bracket for alternatively securing the hand crank to the actuator in one of first and second working positions;
a tubular crank member having two tubular handle portions extending from opposed ends of an angulated central tubular straight portion respectively, said handle portions having central longitudinal axes which are parallel to one another; one of said two handle portions merging into an angulated connecting portion secured to said connector; said connector, when in said first working position, placing said tubular crank member extending horizontally with said two handle portions parallel with said horizontal actuating axis, said handle portions being spaced-apart a vertical and horizontal distance of 8½ inches when measured center to center to achieve a comfortable hand cranking position and a maximum torquing radius; said connector, when in said second working position, said tubular crank member extending angularly downwards at an angle of 33° with respect to said horizontal actuating axis, said central tubular straight portion lying at an inward angle of about 90° from said horizontal actuating axis to maintain said connector rigidly secured to said actuator without the need of an operator applying an inward force to said hand crank.

2. A hand crank as claimed in claim 1 wherein said connector is a jaw connector having a V-shaped slot having a first leg having a longitudinal axis disposed at about 90° with said longitudinal axis of said central tubular straight portion, said actuator having a connecting pin protruding through said V-shaped slot, said hand crank when in said second working position maintaining said pin in an abutment end of said connector when said hand crank is rotated.

3. A hand crank as claimed in claim 1 wherein said tubular crank member has an outer radius of 1.29 inches and a total length of 27.816 inches.

4. A hand crank as claimed in claim 1 wherein said inward angle is precisely 90°.
